(19) United States
(12) Patent Application Publication
(10) Pub. No.: US 2013/0251441 A1
(43) Pub. Date: Sep. 26, 2013

(54) Compact Binder for Storing File Sheet

(71) Applicant: Tang Yol Choi, Charlottesville, VA (US)

(72) Inventor: Tang Yol Choi, Charlottesville, VA (US)

(21) Appl. No.: 13/429,239

(22) Filed: Mar. 23, 2012

(51) Int. Cl. B42F 13/16

(52) U.S. Cl. 402/70

(57) ABSTRACT

A paper binder includes a front cover, a rear cover, a backbone, paper holding rings that pivotally hold sheet protectors, and a strip pivot that supports the paper holding rings. The strip pivot can pivot around the center of the paper holding rings. The strip pivot is provided between the front cover and the backbone, has a shape of a thin plate, and comprises a plurality of holes that engage with the rings. The strip pivot makes an acute angle with the backbone when the paper binder is in closed state, and is substantially perpendicular to the backbone when the paper binder is in open state. The strip pivot and the protective cover are made from a single cover sheet of a predetermined material. The strip pivot is made by folding the sheet and bonding the two plies of the folded portion of the cover sheet.

### BACKGROUND OF THE INVENTION

1. Field of the Invention

The invention is related to a binder for holding sheets of paper. More particularly, the present invention is related to a light and compact binder for holding small number of paper sheets temporarily.

2. Description of the Prior Art

Sheet protectors with a loose leaf binder has widely been used to store paper sheets in its original shape. A sheet protector is made of transparent plastic and divided into two sections, i.e., the area for binding and the area for storing paper sheet. The two sections connected by welding. With the loose leaf binder, however, it is too bulky to store even few sheets due to its structure while it is easy to turn the pages and to manage the number of sheets to be stored, which makes it inadequate for the interactive situation.

Ozeki's U.S. Pat. No. 5,466,008 discloses a method to weld the center of the sheets stacked on the binder, which creates two sheet protectors from one sheet of plastic bag and forms a book-shaped binder. This method is relatively simple to make but the page turning method is not as much convenient as in the loose leaf binder. Furthermore, it is heavily restricted to manage the number of the sheets because of its structure.

Another approach to secure compactness for the binder is to use strips. The strips are made of the file folder itself or attached to the file folder. Each of them has three holes with metal tabs on the surface to bind sheets. This method, however, has much more limits in page turning than Ozeki's at the cost of the management of the sheets.

### SUMMARY OF THE INVENTION

An objective of the invention is to provide a space-efficient paper binder. Another objective of the invention is to provide a paper binder, with which it is easy to turn paper sheets and locate a particular paper sheet.

In order to achieve the objectives, the present invention provides a paper binder comprising a protective cover that comprises a front cover, a rear cover, and a backbone that connects the front cover and the rear cover, a plurality of paper holding rings that are adapted to pivotally hold one or more sheet media, and a ring support device that supports the plurality of the paper holding rings. The ring support device can pivot around the center of the plurality of the rings. The ring support device is protruded from the protective cover.

Preferably, the ring support device is provided between the front cover and the backbone. The ring support device comprises a strip pivot that has a shape of a thin plate, and comprises a plurality of holes that engage with the plurality of paper holding rings.

The strip pivot makes an acute angle with the backbone when the paper binder is in closed state, and the strip pivot is substantially perpendicular to the backbone when the paper binder is in open state.

The strip pivot and the protective cover are made from a single cover sheet of a predetermined material. The strip pivot is made by folding the sheet and bonding the two plies of the folded portion of the cover sheet.

The front cover has a front reinforcing band. The front reinforcing band is made by folding the cover sheet two times and bonding the three plies of the folded portion of the cover sheet. The rear cover has a rear reinforcing band. The rear reinforcing band is made by folding the cover sheet two times and bonding the three plies of the folded portion of the cover sheet.

The width of the backbone is substantially the same as the diameter of the paper holding ring.

The paper binder further comprises an adhesive tape that is attached to part of the front cover to the front reinforcing band, the backbone and part of the rear cover to the rear reinforcing band, whereby the corresponding parts are reinforced.

The front reinforcing band and the rear reinforcing band are close to the paper holding rings but do not contact the paper holding rings.

The sheet medium, which is pivotally held by the paper holding rings, comprises a sheet protector that comprises a transparent plastic bag that is adapted to contain a paper sheet, and a binding strip that comprises holes into which the paper holding rings are inserted.

The advantageous effects of the present invention are: (1) the strip pivot and binder covers are made from one same this plate of paper thereby reducing manufacturing cost; (2) the paper binder is lightweight and compact; (3) turning pages of the paper sheets stored by the binder is free and easy.

### BRIEF DESCRIPTION OF THE DRAWINGS

The accompanying drawings illustrate the best embodiments of the present invention. In the drawings:

FIG. 1 is a perspective view of a paper binder according to the present invention;

FIG. 2 is a cross-sectional view of the paper binder;

FIG. 3 is a perspective view of the paper binder in partially opened state showing exterior of the paper binder;

FIG. 4 is a perspective view of the paper binder in partially opened state showing interior of the paper binder;

FIG. 5 is a perspective view of the paper binder in fully opened state;

FIG. 6 is a front elevation view of a sheet protector;

FIG. 7 is a side elevation view of a cover sheet, which folds into a protective cover and a strip pivot; and

FIG. 8 is a side elevation view of the paper binder.

### DESCRIPTION OF PREFERRED EMBODIMENTS

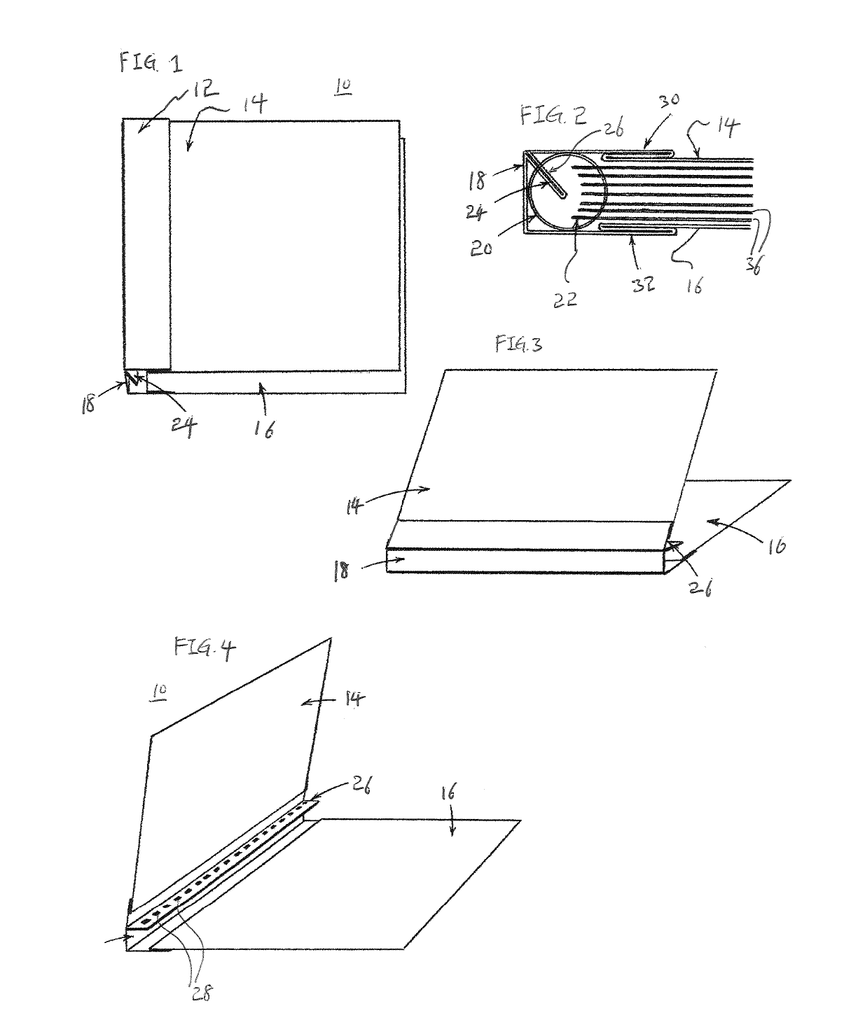

FIG. 1 shows a paper binder 10 comprising a protective cover 12 that comprises a front cover 14, a rear cover 16, and a backbone 18 that connects the front cover 14 and the rear cover 16, a plurality of paper holding rings 20 that are adapted to pivotally hold one or more sheet media 22, and a ring support device 24 that supports the plurality of the paper holding rings 20. The ring support device 24 can pivot around the center of the plurality of the rings 20. The ring support device 24 is protruded from the protective cover 12.

Preferably, as shown in FIG. 2, the ring support device 24 is provided between the front cover 14 and the backbone 18. The ring support device 24 comprises a strip pivot 26 that has a shape of a thin plate, and comprises a plurality of holes 28 that engage with the plurality of paper holding rings 20 (refer to FIG. 4).

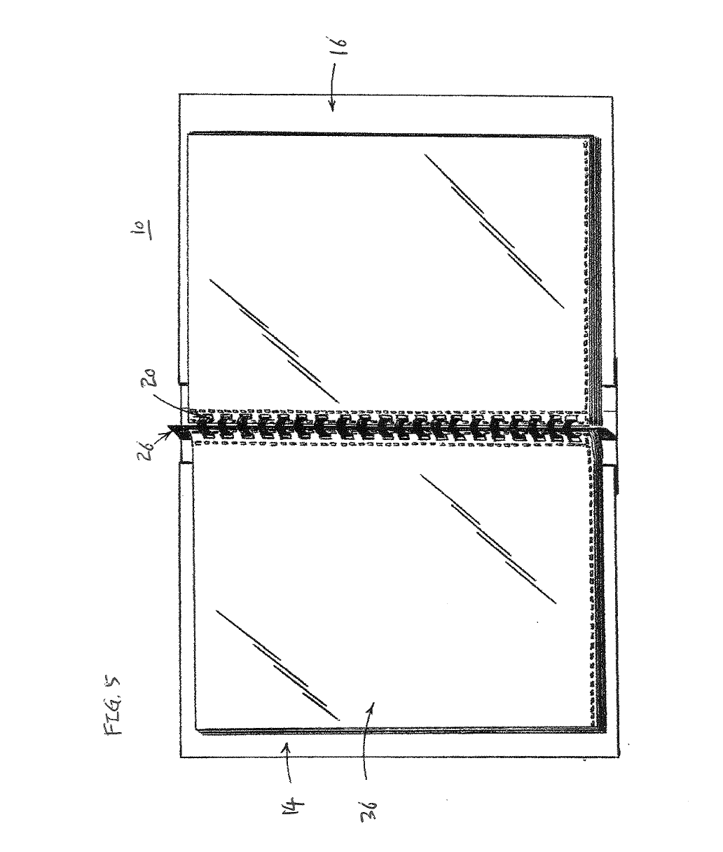

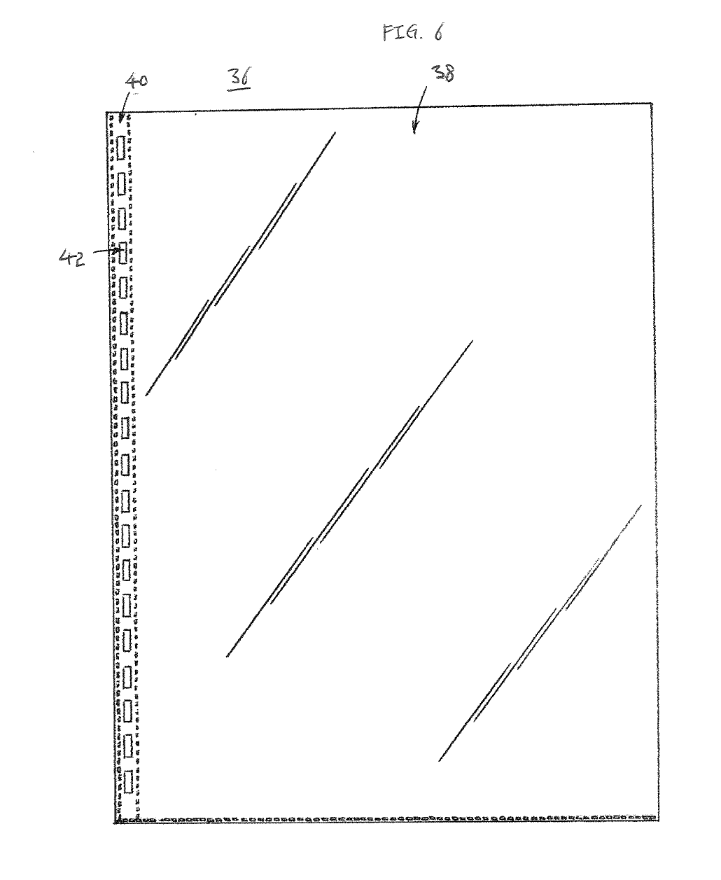

The strip pivot 26 makes an acute angle with the backbone 18 when the paper binder 10 is in closed state (refer to FIG. 2), and the strip pivot 26 is substantially perpendicular to the backbone 18 when the paper binder 10 is in open state (refer to FIGS. 3, 4 and 5).

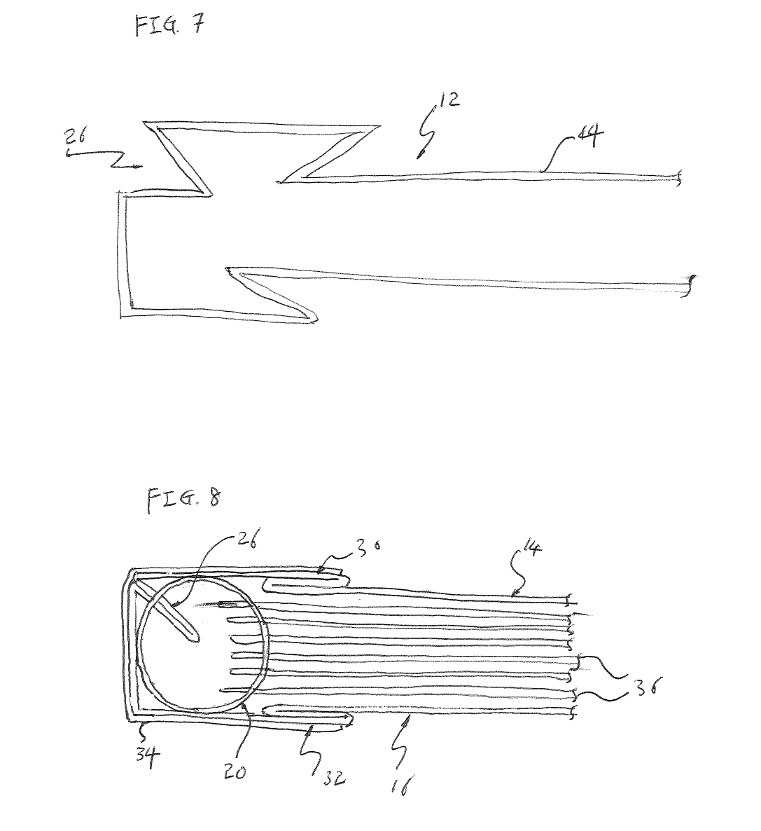

FIG. 7 shows that the strip pivot 26 and the protective cover 12 are made from a single cover sheet 44 of a predetermined material, which includes paper and plastic. The strip pivot 26 is made by folding the cover sheet 44 and bonding the two plies of the folded portion of the cover sheet.

The front cover 14 has a front reinforcing band 30. The front reinforcing band 30 is made by folding the cover sheet two times and bonding the three plies of the folded portion of the cover sheet. The rear cover 16 has a rear reinforcing band 32. The rear reinforcing band 32 is made by folding the cover sheet two times and bonding the three plies of the folded portion of the cover sheet.

The width of the backbone 18 is substantially the same as the diameter of the paper holding ring 20.

The paper binder 10 further comprises an adhesive tape 34 that is attached to part of the front cover to the front reinforcing band 30, the backbone 18 and part of the rear cover to the rear reinforcing band 32, whereby the corresponding parts are reinforced. (refer to FIG. 8).

The front reinforcing band 30 and the rear reinforcing band 32 are close to the paper holding rings 20 but do not contact the paper holding rings 20.

As shown in FIG. 6, the sheet medium 22, which is pivotally held by the paper holding rings 20, comprises a sheet protector 36 that comprises a transparent plastic bag 38 that is adapted to contain a paper sheet, and a binding strip 40 that comprises holes 42 into which the paper holding rings 20 are inserted.

The invention is further explained in relation to its advantageous effects.

The compact binder for the sheet protector allows ‘free and easy page turning’ of the sheets. This invention is comprised of three parts; binder with single strip pivot, comb-binding, and sheet protector. The comb-binding is linked to the strip pivot of the binder to bind sheets. The strip pivot plays a role of the link between the binder and the comb-binding and is bound to the comb-binding like one of the sheets, making the binder to turn completely by the comb-binding.

The strip pivot is single, which is formed by two parts, one from the front or rear cover, the other from the backbone of the folder, contacting each other correspondingly. And it is projecting out inside the binder. The strip pivot is located in the center of the sheets when the binder is open and positioned diagonally when the folder is closed, which makes the binder structure reinforced.

The sheet protector of this invention is also divided into two sections by welding as the existing one; one for binding and the other for storing sheet. However, the width of the binding area in this invention is narrow enough to be efficient in reading sheets compared with the existing sheet protector.

This invention has as many rectangular holes on the binding area for the comb-binding.

This invention as a whole is durable as well as flexible thank to the structure and the flexibility of comb-binding respectively. Also this invention allows the control of the number of the sheets, which is different with the book-shaped binder.

So the binding method has been developed for the sheet protector to be turned freely and easily with the least volume of binder.

The Function of Strip Pivot:

a. Link the comb-binding and the binder.

b. Turn itself on the comb-binding, which allows binder to open fully (360°)

c. Base for coil-binding generally

The Structure of Strip Pivot

a. The strip pivot is formed by two parts, one from the front or rear cover, the other from the backbone of the folder, contacting each other correspondingly. And it is projecting out inside the binder made from one sheet.

b. The strip pivot is located in the center of the sheets when the binder is open and positioned diagonally inside the binder when the binder is closed, which makes the structure of the binder reinforced.

c. The width of the backbone is same to the length of the diameter of the binding basically.

d. The strip pivot is as same as the binding area of the sheet in its size and the shape of the binding hole.

e. This invention is available for all types of coil-binding such as comb, double loop wire, spiral spring, etc.

The Shape of the Binder

The shape or the form of the binder is determined by the method for the bond of strips folded, which is subject to the material of the binder.

Form by Flexible Material

a. Adhesive is adopted for the bond of strip pivot itself when the material of the binder is paper or flexible plastic.

b. The backbone of the binder including the boundary backbone and binder covers is reinforced by the adhesive tape when the material of the binder is paper or soft plastic.

Form by Durable Material

With the durable plastic binder, it is by welding the edges of the four sides of the strip pivot for the bond of strip pivot itself.

The Cover of the Binder

This invention has the two-folded covers to reinforce the structure of this invention in case with soft material for the binder

The Structure of the Binder Cover

a. The part of the cover which is closer to the backbone is folded inside firstly and folded outside secondly, making rectangular parallel to the backbone. The contacting areas of the folded parts are adopted adhesive.

b. The inside part folded is not contacting any part of the comb-binding.

c. The binder covers are symmetric from the backbone.

The Functions and Effects of this Invention

a. The strip pivot is thicker than the rest part of the binder, which causes the covers of binder to lift up. But with the two-folded cover, the part of the cover folded secondly pulls the part of cover lifting up down to the inside binder, making the binder covers flat.

b. This invention plays a role of shock-absorber protecting the comb-binding when the binder is closed.

c. This invention minimizes the space between the binder cover and the sheets bound so as to hold the sheets firmly.

d. Together with the backbone and the strip pivot, the two-folded cover contributes to the structure of the binder to be reinforced to prevent sheets from being twisted.

Sheet Protector

a. This invention adopts sheet protector which is made of transparent plastic bag. The sheet protector is also divided into two sections; one for binding and the other for storing sheet by welding. The width of the binding area in this invention is narrow enough to be efficient in reading sheets compared with the existing sheet protector.

b. The binding area has the white plastic between the transparent plastic covers.

c. The width of the binding area in this invention is ⅜ inches including welding parts or ¼ inches of inside the binding area while the existing sheet protector has been established ⅝ inches in width of binding area including welding parts or ½ inches of inside the binding area.

d. This invention has as many rectangular holes on the binding area for the comb-binding. But all types of shape for the binding holes are available.

1. A paper binder comprising:
a) a protective cover that comprises a front cover, a rear cover, and a backbone that connects the front cover and the rear cover;
b) a plurality of paper holding rings that are adapted to pivotally hold one or more sheet media.
c) a ring support device that supports the plurality of the paper holding rings;
wherein the ring support device can pivot around the center of the plurality of the paper holding rings; wherein the ring support device is protruded from the protective cover.

2. The paper binder of claim 1, wherein the ring support device is provided between the front cover and the backbone, wherein the ring support device comprises a strip pivot that has a shape of a thin plate, and comprises a plurality of holes that engage with the plurality of paper holding rings.

3. The paper binder of claim 2, wherein the strip pivot makes an acute angle with the backbone when the paper binder is in closed state, and wherein the strip pivot is substantially perpendicular to the backbone when the paper binder is in open state.

4. The paper binder of claim 3, wherein the strip pivot and the protective cover are made from a single cover sheet of a predetermined material, wherein the strip pivot is made by folding the sheet and bonding the two plies of the folded portion of the cover sheet.

5. The paper binder of claim 4, wherein the front cover has a front reinforcing band, wherein the front reinforcing band is made by folding the cover sheet two times and bonding the three plies of the folded portion of the cover sheet, wherein the rear cover has a rear reinforcing band, wherein the rear reinforcing band is made by folding the cover sheet two times and bonding the three plies of the folded portion of the cover sheet.

6. The paper binder of claim 5, wherein the width of the backbone is substantially the same as the diameter of the paper holding ring.

7. The paper binder of claim 6, further comprising an adhesive tape that is attached to part of the front cover to the front reinforcing band, the backbone and part of the rear cover to the rear reinforcing band.

8. The paper binder of claim 6, wherein the front reinforcing band and the rear reinforcing band are close to the paper holding rings but do not contact the paper holding rings.

9. A paper binder comprising:
a) a protective cover that comprises a front cover, a rear cover, and a backbone that connects the front cover and the rear cover;
b) a plurality of sheet media;
c) a plurality of paper holding rings that pivotally hold the sheet media.
d) a ring support device that supports the plurality of the paper holding rings;
wherein the ring support device can pivot around the center of the plurality of the paper holding rings; wherein the ring support device is protruded from the protective cover.

10. The paper binder of claim 9, wherein the sheet medium comprises a sheet protector that comprises a transparent plastic bag that is adapted to contain a paper sheet, and a binding strip that comprises holes into which the paper holding rings are inserted.

11. The paper binder of claim 10, wherein the ring support device is provided between the front cover and the backbone, wherein the ring support device comprises a strip pivot that has a shape of a thin plate, and comprises a plurality of holes that engage with the plurality of paper holding rings.

12. The paper binder of claim 11, wherein the strip pivot makes an acute angle with the backbone when the paper binder is in closed state, and wherein the strip pivot is substantially perpendicular to the backbone when the paper binder is in open state.

13. The paper binder of claim 12, wherein the strip pivot and the protective cover are made from a single cover sheet of a predetermined material, wherein the strip pivot is made by folding the sheet and bonding the two plies of the folded portion of the cover sheet.

14. The paper binder of claim 13, wherein the front cover has a front reinforcing band, wherein the front reinforcing band is made by folding the cover sheet two times and bonding the three plies of the folded portion of the cover sheet, wherein the rear cover has a rear reinforcing band, wherein the rear reinforcing band is made by folding the cover sheet two times and bonding the three plies of the folded portion of the cover sheet.

15. The paper binder of claim 14, wherein the width of the backbone is substantially the same as the diameter of the paper holding ring.

16. The paper binder of claim 15, further comprising an adhesive tape that is attached to part of the front cover to the front reinforcing band, the backbone and part of the rear cover to the rear reinforcing band.

17. The paper binder of claim 15, wherein the front reinforcing band and the rear reinforcing band are close to the paper holding rings but do not contact the paper holding rings.
